(19) United States
(12) Patent Application Publication
(10) Pub. No.: US 2009/0094089 A1
(43) Pub. Date: Apr. 9, 2009

(54) CUSTOM DISPATCH SOFTWARE

(76) Inventors: Michael Anthony Iacovone, Clermont, FL (US); Adhir Chobe, Port Orange, FL (US); Taras Zherukha, Port Orange, FL (US)

Correspondence Address: Masco Corporation, 21001 Van Born Road, Taylor, MI, 48480, US

(21) Appl. No.: 11/867,779

(22) Filed: Oct. 5, 2007

(51) Int. Cl. G06Q 10/00

(52) U.S. Cl. 705/9

(57) ABSTRACT

A system and method for a dispatching program and for its implementation, involves logging into a system, selecting or creating a work unit, and assigning work orders to the selected unit. After the work orders have been assigned the assignments are transmitted to each work crew.

### BACKGROUND OF THE INVENTION

The present application relates generally to a system and method for dispatching and tracking work orders and work crews.

It is known in the art to have pre-configured work crews with assigned equipment. It is also known to schedule work orders to these crews as much as several months in advance. Under such a scheduling method, it becomes unnecessary to utilize a dispatching process beyond informing the work crew of their assigned work orders. This scheduling procedure leads to inflexibility and can result in significant delays in accomplishing tasks.

When a member of a crew takes off work, or must be absent, and that member is the sole member of the crew to have a vital skill (such as being a licensed driver, being a certified electrician, etc.), then any work orders requiring that skill cannot be accomplished until that crew member is either replaced or returns. This can result in a large backlog of work orders when a scheduling and dispatch system such as the one above is used.

It is therefore desirable to create a system and method where work orders are not assigned to a work crew until they are ready to be dispatched. Additionally, it is desirable to create a dispatch system where a user is capable of sorting the work orders by any criteria in order to facilitate better resource management. It is additionally desirable to allow the dispatcher to assign priorities to a work order and to have those priorities remain associated with the work order throughout the entire process.

### SUMMARY OF THE INVENTION

The applicant has devised a system and method for dispatching work orders. When a user logs into a dispatch system, he is presented with an interface which allows him to perform the steps necessary to dispatch a work order. The first action taken to dispatch a particular work order is to either create a dispatchable unit, or find an available dispatchable unit. Next, the user assigns company resources and employees to the dispatchable unit creating a work crew. This process may be done multiple times, creating or finding multiple work crews in order to aide in the dispatch process. Next, the user assigns work orders to dispatchable units based on any number of criteria. Once the work orders have been assigned to work crews, the dispatch program transmits the information to a work order dispatch receiver associated with each crew.

These and other aspects of the application can be best understood from the specification and drawings. Following is a brief description of the drawings.

### BRIEF DESCRIPTION OF THE DRAWINGS

FIG. 1 is a flowchart illustrating an embodiment of the dispatch process.

FIG. 2 is a sample user interface screen that is displayed in an embodiment of the dispatch process.

FIG. 3 illustrates a system that could be used to implement one embodiment of the application.

### DETAILED DESCRIPTION OF THE PREFERRED EMBODIMENT

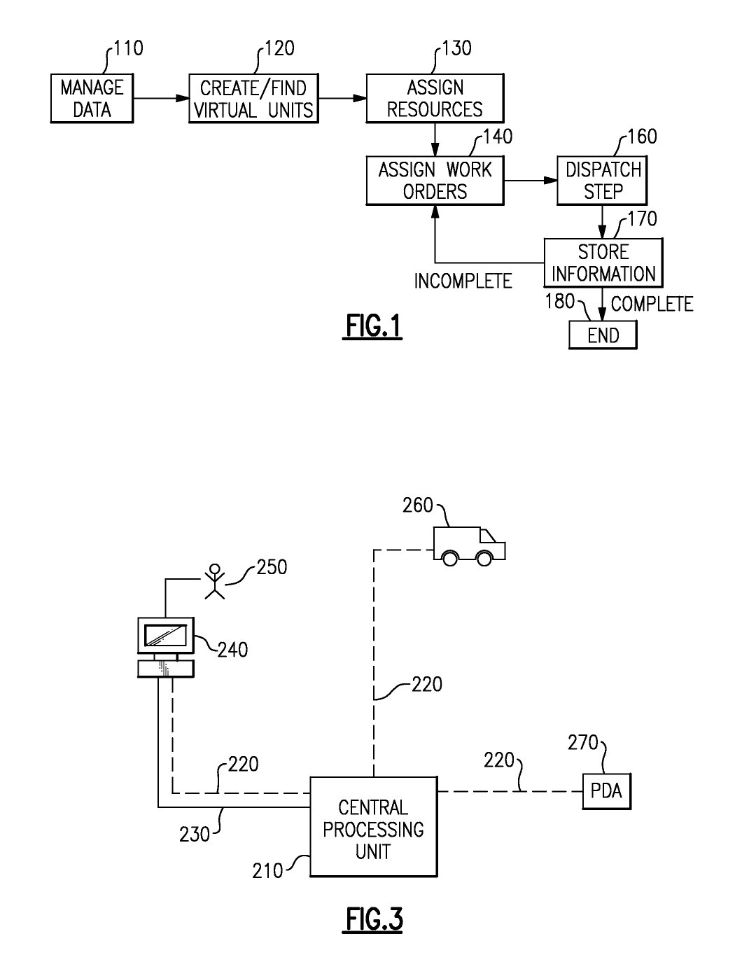

Disclosed is a system for dispatching work orders to specific crews and trucks and tracking their progress. FIG. 1 illustrates an embodiment of the system that could be used when work orders have been scheduled for a specific day, but not to a specific unit prior to dispatch. Initially, a user opens a user interface and logs into the software. Some embodiments include a “varying levels of access” feature where users with a certain access level are allowed to make modifications to the scheduling of a given day, and other users are only allowed to view the status of the scheduling for a given day. The initial step in FIG. 1 is the manage data step 110. In the manage data step 110, any information necessary for the dispatch software is retrieved from a database, and any information not contained in the database may be entered by a user 250, see FIG. 3. After all the necessary information has been retrieved, the software proceeds to the create default crews step 120.

In the create default crews step 120, the user 250 is presented with a screen where he can search for currently established dispatchable units. The units will typically consist of a truck and a crew assigned to the truck, however the units may consist of any distribution of company resources and work crews. If there are not enough dispatchable units, the user 250 is able to create more in this step. In order to create a new dispatchable unit the user 250 uses an option available in the user interface to create an empty dispatchable unit. This empty dispatchable unit may then be filled with any resources desired. When creating the empty dispatchable unit the user 250 can assign a specific product or trade line to it. This product or trade line may be used to determine what resources (such as type of truck, crew, equipment, etc.) would be assigned to that dispatchable unit. After any necessary dispatchable units are created or found they may be opened and the software proceeds to the assign resources step 130.

In the assign resources step 130, the user 250 is capable of assigning any necessary resources to dispatchable units to complete work orders. Additionally, in the assign resources step 130, the user 250 assigns crew and resources to any new dispatchable units which were opened in the create and find dispatchable units step 120. Assignments made in the assign resources step 130 are stored in memory and do not reset until they are manually overridden. In order to manually override an assignment, the user 250 re-assigns a given resource to a different dispatchable unit or removes the resource from the dispatchable unit. When work crew members are assigned as a part of the assign resources step, some embodiments of the software allow traits to be assigned to the crew members. These traits could be “licensed driver,” union grades and levels, skill sets, or any other special qualifications a crew member might have. Implementation of this option in an embodiment allows the software to perform a check in the assign resources step to ensure that a given work crew can complete the assigned work order.

It is additionally anticipated that some embodiments could incorporate a payroll scheme within the assign resources step 130 to aid in payroll management. Under such a scheme, each unit would be assigned a certain overall amount of money associated with the amount of work it could complete. Each member of the work crew assigned to the dispatchable unit would then be assigned a percentage of the amount of money. Finally, the software would compare the total percentages to ensure that no more than 100% of a unit's amount of money is assigned to a work crew associated to the unit. This optional addition aides the payroll department in determining how much compensation should be paid to each member of a given work crew for particular days work. After all resources have been assigned to the dispatchable unit, the software proceeds to the assign work orders step 140.

In the assign work orders step 140, the user 250 assigns work orders retrieved in the manage data step 110 to dispatchable units. In this step, the user 250 is capable of sorting the work orders based on job type, required skill set, or any other criteria. This functionality allows the user to determine which work orders should be assigned to which dispatchable units based on each dispatchable unit's available resources. As each work order is assigned, the user 250 has the option of including any completion priorities along with the work order. Examples of these completion priorities could be, but are not limited to, AM, PM, first, second, high, medium, or low.

Each dispatchable unit has a labor dollar capacity associated with it which is indicative of the amount of labor it can perform in a given day. When a work order is assigned to a dispatchable unit, the software checks the required labor dollar amount of the work order against the remaining available labor dollar capacity of the dispatchable unit. The software then gives a visual cue if the dispatchable unit's labor dollar capacity for the day has been exceeded. It is additionally anticipated that a color coding system could be implemented to allow a user 250 to determine approximately how much of a dispatchable unit's labor dollar capacity has been filled by scheduled work orders. Additionally performed in this step is the generation of a pick list. The pick list contains a list of all the materials necessary to complete a work order, as well as an order that the materials should be loaded into a truck. After all necessary work order assignments have been performed, the software proceeds to the dispatch step 160.

In the dispatch step 160, the software transmits the work order assignments to a work order dispatch receiver device associated with each dispatchable unit. The work order dispatch receiver device may be a truck mounted device 260, or a personal digital assistant (PDA) 270, or any other device capable of receiving and displaying information associated with the work order. During the dispatch step 160, the work crew performs the work orders that have been assigned to it. Upon completion of a work order, the work crew may send a work order complete signal back to the central processing unit 210 where the work order is flagged as completed. When the work crew has finished working for the day, a signal is sent back indicating that the crew has stopped working and any incomplete work orders are flagged for completion during the next day. After the central processing unit 210 has received this information, it proceeds to the store information step 170.

In the store information step 170, the central processing unit 210 stores information transmitted from the truck mounted device 260 or the PDA 270 associated with the work order. This information typically includes, but is not limited to, a complete or incomplete status, a progress report on an incomplete work order, or an unable to perform work order status. Once the software has stored this information in a database, any incomplete work orders are assigned to the same work crew for completion on the next day. The software does this by leaving the specific work order associated with the work crew. This allows the user 250 to see that there is a holdover work order still associated with a work crew, when the user 250 initiates the dispatch program the next day. After all associated information has been stored, and any incomplete work orders are flagged for completion the next day, the program proceeds to the end step 180 where it wraps up any processes and shuts down.

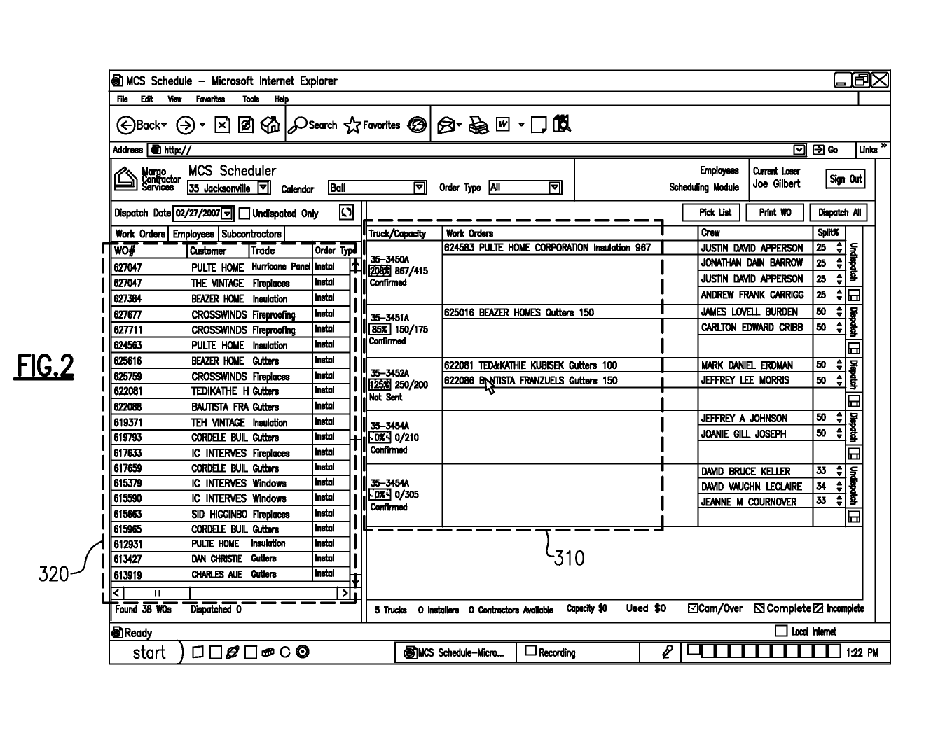

FIG. 2 illustrates a sample user interface that a user 250 would see while interacting with the software. In the dispatchable unit section 310 of the screen, each dispatchable unit is broken down and any work orders assigned to a given dispatchable unit are listed to the right of the dispatchable unit. Immediately to the left of the dispatchable unit section 310 is a work order list 320. The work order list 320 contains a listing of all the work orders that should be scheduled for a given day, as well as certain information associated with them to aid the dispatcher. Examples of information that could be associated with the work order list 320 are what trade the work order is in, what type of job it entails, and customer name.

FIG. 3 illustrates a physical configuration designed to implement the system of this application. The physical system contains a central processing unit 210 with a computer readable medium which stores the instructions for executing the process described above. Connected to the central processing unit 210 by either a wireless connection 220 or a physical connection 230 is a dispatch computer 240. The dispatch computer 240 is capable of accessing the central processing unit and running the process described above. A user 250 operates the dispatch computer and is capable of inputting information or performing any tasks required of the user 250. A truck mounted device 260 or a PDA 270 is capable of wireless communication with the central processing unit 210 through a wireless connection 220. Each of the truck mounted devices 260 and the PDAs 270 are capable of displaying any information associated with the work order, and may have the additional capability of printing out a work order ticket.

Where the term “work crew” has been utilized, it should be understood that this invention would extend to any company resources, including one man “crews.”

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of dispatching work orders comprising:
(a) logging into a work order dispatch program;
(b) selecting an existing dispatchable unit;
(c) creating a dispatchable unit when no adequate existing dispatchable unit is found;
(d) assigning a company resource to said dispatchable unit;
(e) assigning work orders to said dispatchable unit based on any number of criteria; and
(f) transmitting information contained within said dispatchable unit to a work order dispatch receiver device.

2. The method of claim 1 further comprising the step of performing a check to ensure that said company resource assigned to said dispatchable unit contains a crew member with a valid drivers license.

3. The method of claim 1 further comprising the step of assigning completion priorities to said work orders.

4. The method of claim 1 further comprising the step of providing a user the option of generating a pick list containing a dispatchable unit data set upon transmission of said dispatchable unit data.

5. The method of claim 1 further comprising the step of determining a level of access for a user, and determining what functionality is available to said user based on said level of access.

6. The method of claim 5 wherein the step of determining a level of access occurs between steps 1 and 2.

7. The method of claim 1 further comprising the step of assigning specific identifiers to any crew members assigned to a truck, where said specific identifiers correspond to said crew members skill sets.

8. The method of claim 1 further comprising the step of assigning an amount of pay to each dispatchable unit, and assigning a percentage of said amount of pay to each crew member assigned to a dispatchable unit.

9. The method of claim 8 wherein the step of assigning an amount of pay additionally comprises, checking to ensure that a sum of said percentage of amount of pay assigned to all resources in a dispatchable unit does not exceed 100%.

10. The method of claim 1 wherein step 3 additionally comprises sorting said work orders based on at least one criterion.

11. The method of claim 1 further comprising the step of transmitting any updates or finalizations of a work order to a corresponding work order dispatch receiver device.

12. The method of claim 1 further comprising the step of storing all dispatch data to a database for future access.

13. The method of claim 1 further comprising the step of continuously updating the work order dispatch receiver device with information regarding the work order.

14. The method of claim 1 further comprising the step of receiving a work order finished signal transmitted from said work order dispatch receiver device when a condition is met.

15. The method of claim 1 further comprising the step of storing a completed work order status to a database of work orders.

16. A system for dispatching scheduled work orders to work crews comprising:
a data entry device for interfacing with a dispatch program;
a central processing unit for executing said dispatch program;
a computer readable medium containing software with instructions for executing said dispatch program; and
a mobile dispatch receiver device comprising a screen capable of displaying information associated with a received work order.

17. The system of claim 16, wherein said central processing unit is capable of sending signals to and receiving signals containing at least information regarding dispatched work orders from said mobile dispatch receiver device.

18. The system of claim 16, wherein said data entry device and said central processing unit are the same device.
